(19) United States
(12) Patent Application Publication
(10) Pub. No.: US 2018/0266167 A1
(43) Pub. Date: Sep. 20, 2018

(54) DOOR FRAME PROTECTOR

(71) Applicant: FRANK NOVAK & SONS, INC., Cleveland, OH (US)

(72) Inventor: MARK A. PINCHOT, SOLON, OH (US)

(21) Appl. No.: 15/920,504

(22) Filed: Mar. 14, 2018

Related U.S. Application Data
(60) Provisional application No. 62/472,150, filed on Mar. 16, 2017.

(51) Int. Cl. E06B 1/34; E04F 19/02

(52) U.S. Cl. CPC E06B 1/34; E04F 19/028

(57) ABSTRACT

A door frame protector includes a tube having a slot which extends the entire length of the tube. The tube is preferably a wound paper tube 12-96 inches long. The tube is sufficiently resilient so that it can be opened and placed around a door jamb and then released so that the edges of the slot compressively engage the wall adjacent the door jamb. The protector can protect a new or freshly painted door jamb from damage from being hit or bumped when a building is under construction.

The present application claims the benefit of U.S. Provisional Patent Application No. 62/472,150 filed on Mar. 16, 2017, the entire contents of which is incorporated herein by reference.

### FIELD OF THE INVENTION

The present invention relates to a door frame protector. The door frame protector protects door frames, particularly door jambs, from damage, particularly when a building is under construction and/or when articles, such as equipment and furniture, are being moved in or out of the building or rooms of the building.

### DESCRIPTION OF RELATED ART

When a building is under construction and/or articles, such as equipment and furniture, are being moved in or out of the building or rooms in the building, door frames are exposed and susceptible to damage by being hit or bumped. For example, when a door frame, including a door jamb, is freshly painted, protection may be desired while the building remains under construction. Accordingly, there is a need for a door frame protector that can protect door frames from such damage.

### SUMMARY OF THE INVENTION

A door frame protector comprising a tube which is 12-96 inches long and which has a slot extending the entire length of the tube, the tube having a first edge and a second, opposing, edge defined by the slot, the tube being sufficiently resilient such that the tube can be opened and placed around a door jamb and then released with the first edge and the second edge then compressively engaging a wall adjacent the door jamb. The invention also includes a method of protecting a door jamb of a door frame, comprising the following steps:

a) providing a tube which is 12-96 inches long and which has a slot extending the entire length of the tube, the tube having a first edge and a second, opposing, edge defined by the slot;
b) increasing a width of the slot and placing the tube around at least a portion of the door jamb and permitting the width of the slot to decrease so that at least a portion of the door jamb is within the tube and the first and second edges of the tube compressively engage a wall adjacent the door jamb.

### BRIEF DESCRIPTION OF THE DRAWINGS

FIG. 1 is a perspective view of a door frame protector according to the invention.

FIG. 2 is a front elevational view of the door frame protector of FIG. 1.

FIG. 3 is a right side elevational view of the door frame protector of FIG. 1, the left side elevational view being a mirror image thereof.

FIG. 4 is a back elevational view of the door frame protector of FIG. 1.

FIG. 5 is a top plan view of the door frame protector of FIG. 1, showing the protector having a circular cross section.

FIG. 6 is an elevational view showing the door frame protector of FIG. 1 installed on a door jamb.

FIG. 7 is an elevational view of the door frame protector of FIG. 1 with an advertisement thereon.

FIG. 8a is a front elevational view of a door frame protector according to a further embodiment of the invention.

FIG. 8b is a front elevational view of a door frame protector according to a further embodiment of the invention.

FIG. 8c is a front elevational view of a door frame protector according to a further embodiment of the invention.

### DETAILED DESCRIPTION OF PREFERRED EMBODIMENTS OF THE INVENTION

The terminology as set forth herein is for description of the embodiments only and should not be construed as limiting the invention as a whole.

Herein, when a range such as 5-25 (or 5 to 25) is given, this means preferably at least 5 and, separately and independently, preferably not more than 25. In an example, such a range defines independently at least 5, and separately and independently, not more than 25.

As used herein, the term “resilient” means able to recoil or spring back or regain some or all of its shape after being bent, stretched, compressed or deformed. A door frame typically includes two vertical door jambs and a header connecting the tops of the two door jambs.

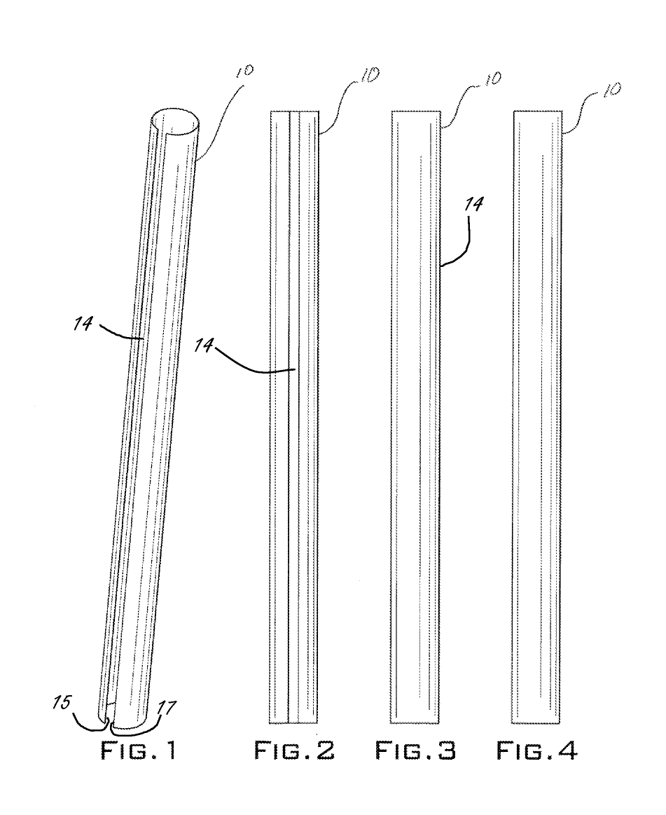

With reference to FIGS. 1-7, there is shown a door frame protector 10. In this embodiment, the door frame protector 10 is a tube or a tubular member, but the door frame protector 10 may be any shape suitable to cover or surround a door jamb or door header. The tube 10 can have, in cross section, a circular, rectangular, oval, pentagonal, or other shape. The door frame protector 10 is preferably a tube 10 of 3-8 or 3-7 or 3.5-6, more preferably 4-6.5 or 4-6 or 4.5-6 or 4-5.5 or 4-5 or about 4.5, inches in inner or interior diameter and about 12-96, 24-94, 30-90, 40-80, 45-75, 50-70, 55-65 or about 60, inches long, alternatively 36-60, 42-54, 45-51, 47-49 or about 48, inches long.

The tube 10 has a slot 14 cut lengthwise the entire length of the tube, preferably parallel to the longitudinal axis. The slot 14 can be so narrow that it is a slit where the edges 15, 17 are touching. The first edge 15 and the second edge 17 are opposing each other. Preferably the slot 14 is 1/100-5, 1/100-4, ⅛-3, 0.4-2, 0.25-1.5, 0.5-1.5, 0.75-1.25 or about 15/16 or about 1, inches wide. Alternatively the slot 14 can be 0.75-2.5 or 1-2 inches wide, or the width can be about 1-2 inches less than the typically thickness (frequently 5 inches) of a wall adjacent a door frame in typical commercial, industrial or residential construction in the USA. Alternatively, the slot can be not more than 2, 3, 4 or 5 inches and/or can be at least 1, 2, 3 or 4 inches, wide. The tube 10 has a “C” shape in cross-sectional view.

The tube 10 is preferably non-metal and may be made of paper, plastic, rubber, polymers, paperboard, cardboard, fiberboard, or any other suitable or similar material known in the tubing art. The tube wall thickness is preferably 0.5-8, 1-6, 2-5 or 3-4 mm. The tube is preferably paperboard or cardboard as known in the tubing art, such as stiff 0.05 inches gauge cardboard or paperboard tubing, or it can be thicker or thinner by at least or not more than 10%, 25%, 50%, 75%, 100%, 200%, 300% or more. The cardboard or paper tube can be helically spun, bonded, latex bonded, or adhesively bonded, kraft paper or other paper, woven or spun to a 0.05 inch wall thickness, or similar cardboard or paperboard or fiberboard as known in the tubing art or similar material with similar characteristics. Preferably the tube is a paper tube, preferably a wound paper tube, preferably spiral or helically wound, preferably plain paper or Kraft paper. Suitable wound paper tubes include those available from Newkor Inc., 10410 Berea Road, Cleveland Ohio 44102, from Custom Paper Tubes, 15900 Industrial Parkway, Cleveland Ohio 44135, or available as Sonotubes from Sonoco Products Company, located in Hartsville, S.C. The slotted tube must be springy and resilient enough to work as described below.

The door frame protector 10 can also include a protective or polymeric layer/coating preferably on an exterior surface, preferably the entire exterior surface. For example, a plastic coating made of polyethylene or polyethylene terephthalate over the exterior surface of the door frame protector 10 can improve the water resistance, tear strength, and/or abrasion resistance of the door frame protector 10. The door frame protector 10 may also include an advertisement 18 having a name and/or logo, preferably on the exterior surface, as shown in FIG. 7.

In another embodiment, the door frame protector 10 may be made of plastic, including rigid or corrugated plastic, or any other suitable resilient material known in the tubing art.

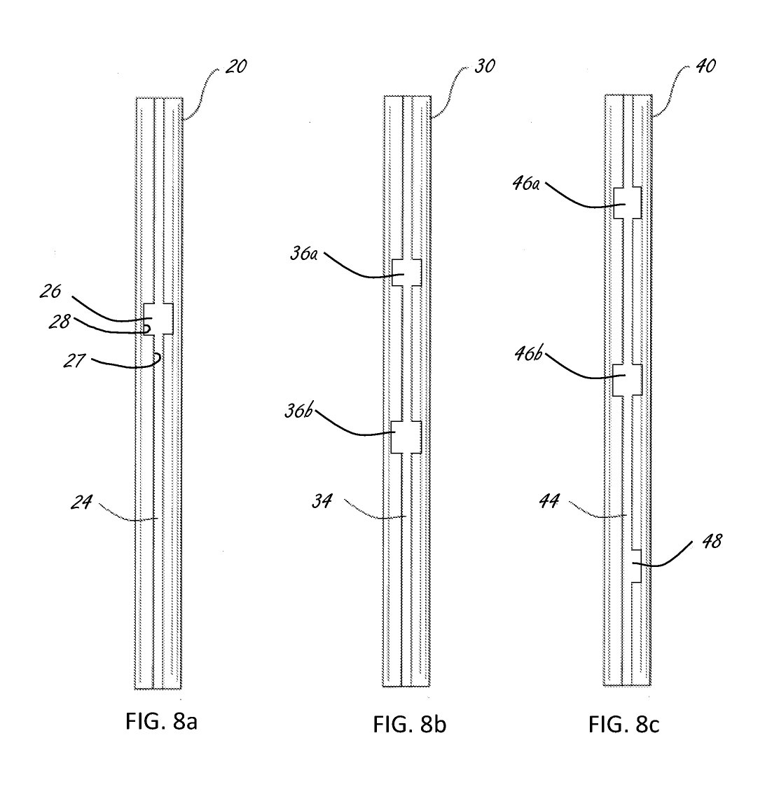

In some embodiments, in FIGS. 8a-8c, cutouts or handholds or handhold cutouts 26, 36a, 36b, 46a, 46b, 48, are provided in at least a portion of an edge or edges of the slot 24, 34, 44 of the door frame protector 20, 30 40. The longitudinal length of a cutout 26 may be preferably from 3 inches to 6 inches, more preferably from 2.5 inches to 5.5 inches, and more preferably from about 4 inches to about 5 inches. The depth of the cutout 26 (distance cut laterally from the edge 27 of the slot 24 into the body of the tube ending at 28) is preferably 0.5 inches to 1 inch or about 0.5 inches to 1.5 inches. The door frame protector 10 may include one set of cutouts or a plurality of sets of cutouts, preferably evenly spaced along the tube. For example, FIG. 8a shows a door frame protector 20 having one pair of cutouts 26 along the edges of the slot 24. FIG. 8b shows a door frame protector 30 having two pairs of cutouts 36a, 36b along the edges of the slot 34. FIG. 8c shows a door frame protector 40 having two pairs of cutouts 46a, 46b along both edges of the slot 44 and a single cutout 48, where there may otherwise be a pair, along one edge of the slot 44. The door frame protector 10, 20, 30, 40 may also have three, four, five, six, seven, or eight or more pairs of cutouts. The cutouts can assist in installation and removal of the door frame protector 10, making it easier for a user to pry open the protector and put it around the door frame.

The door frame protector 10 may be of an appropriate diameter, appropriate thickness, and appropriate material so that it can be sprung or pried open, placed around a conventional door frame, and snapped back into position so it grips or compressively engages the wall adjacent the door frame (eg., adjacent the door jamb). The tube 10 can be cut to length and then machined by cutting with a pair of adjacent saw blades to provide the slot the entire length of the tube to create the “C” shape. When the tube 10 is a paper tube or made of paper, paperboard, cardboard or fiberboard, the cutting with saw blades tends to leave the edges 15, 17 disheveled or abraded or soft or fluffy, as a result of which the edges 15, 17 are less likely to scratch the door jamb or adjacent wall.

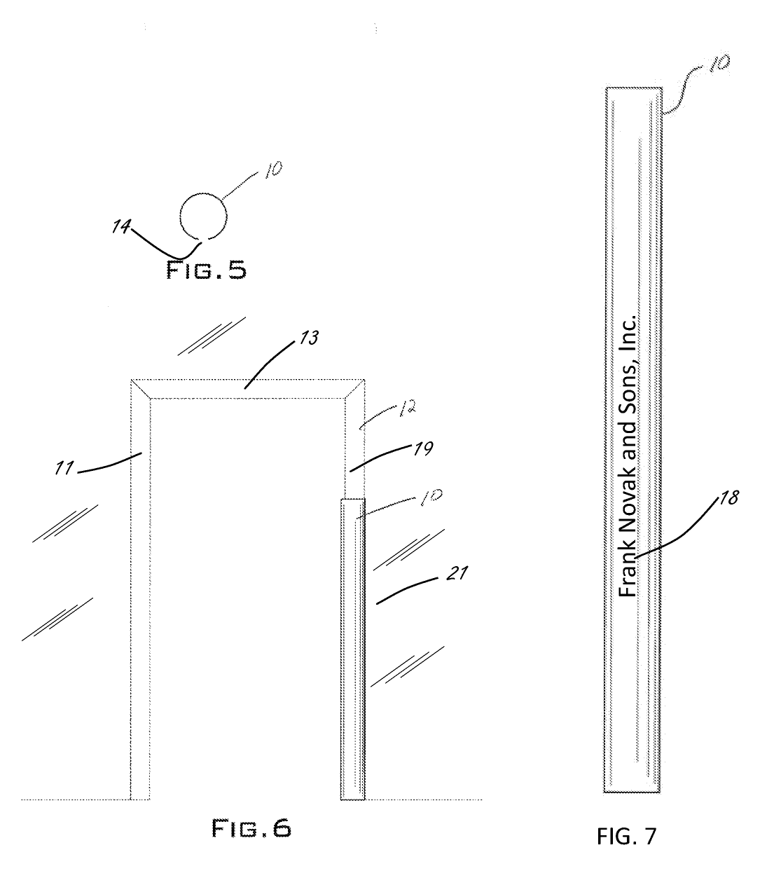

The following is an example embodiment of how a door frame protector 10 can be used or mounted on a door frame 12, as shown in FIG. 6. As illustrated in FIG. 6, a door frame 12 comprises a first upright door jamb 11, a second upright door jamb 19, and a header 13. The thickness (the distance perpendicular to the plane of the adjacent wall 21) of the door jamb 11, 19 is preferably from 3 inches to 10 inches, more preferably from 4 inches to 8 inches, and most preferably from 4 inches to 6 inches. The width (the distance parallel to the plane of the adjacent wall 21) of the door jamb 11, 19 is preferably from 1 inch to 5 inches, more preferably from 1.5 inches to 3.5 inches or 2 inches to 3 inches, and most preferably from 2 inches to 2.5 inches, or about 2.5 inches. The door frame 12 may be comprised of metal or wood. The wall and/or door jamb can also be comprised of concrete blocks with a door jamb thickness (perpendicular to the plane of the adjacent wall) of about 4 inches, about 6 inches, about 8 inches, about 10 inches or about 6-9 inches. The diameter of the tube 10 and the width of the slot 14 are selected as necessary to fit over the door jamb 11, 19 so that the edges 15, 17 of the tube 10 will compressively engage the wall 21 adjacent the door jamb and the end of the tube will contact the floor. The wall 21 preferably has a thickness 1 inch less than the adjacent door jamb, for example, the wall 21 is preferably 3-7, 4-6 or about 5, inches thick. When the slot 14 is pried or flexed open by hand, (to mount the tube 10), the width of the slot 14 is preferably increased by at least 100% to 600%, more preferably by at least 150% to 375%, and most preferably by at least 150% to 300%. For mounting, the width of the slot is increased and the resilient tube 10 is then placed around at least a portion (preferably a lower portion) of the door jamb 11 or 19 and the width of the slot is permitted to decrease so that at least a portion of the door jamb 11 or 19 is within the tube 10 and the edges 15, 17 of the tube compressively engage the wall 21 adjacent the door jamb. As noted, the width of the slot 14 is permitted to recoil or return to, or at least part way to, its original width so that the door jamb remains within the tube 10 and the edges 15, 17 compressively engage the adjacent wall 21 from the resilience of the tube 10. A shorter tube 10 can be placed around the header 13 to protect that part of the door frame. The tube 10 is sufficiently resilient or springy such that the tube can be opened and placed around a door jamb and then released with the first and second edges (such as edges 15, 17) then compressively engaging a wall (e.g. wall 21) adjacent the door jamb (e.g. door jamb 19).

When the door frame protector 10 is no longer in use, it may be removed and stored for future re-use.

The door frame protector can be used to protect a door frame from damage. For example, the door frame protector can be used after a door frame is painted but is still susceptible to damage, such as scratches, dings, and/or dents. The door frame protector can be used to prevent such damage during construction of a building, when objects are moved into or out of a room and/or building, or any other type of event where a door frame may be bumped, hit, scratched, or otherwise damaged. Once the potentially damaging event concludes, the door frame protector may be removed without the use of tools and stored for future use.

As mentioned, the door frame protector can be used in advertising. For example, a name, logo, and/or any other advertisement of a store or person may be printed, preferably on the exterior of the door frame protector.

Although the above described embodiments of the invention constitute preferred embodiments, it should be understood that modifications can be made thereto without departing from the scope of the invention as set forth in the appended claims.

What is claimed is:

1. A door frame protector comprising a tube which is 12-96 inches long and which has a slot extending the entire length of the tube, the tube having a first edge and a second, opposing, edge defined by the slot, the tube being sufficiently resilient such that the tube can be opened and placed around a door jamb and then released with the first edge and the second edge then compressively engaging a wall adjacent the door jamb.

2. The door frame protector of claim 1, wherein the tube has an inner diameter of 3 to 8 inches.

3. The door frame protector of claim 1, wherein the tube has a length of 30 to 90 inches.

4. The door frame protector of claim 1, wherein the slot has a width of ⅛ inch to 3 inches.

5. The door frame protector of claim 1, wherein the tube has a wall thickness of 0.5 to 8 mm.

6. The door frame protector of claim 1, wherein the tube has an advertisement on an exterior surface.

7. The door frame protector of claim 1, wherein the tube has one or more handhold cutouts.

8. The door frame protector of claim 1, wherein the tube is made of paper, cardboard, paperboard or fiberboard.

9. The door frame protector of claim 1, wherein the tube is a paper tube.

10. The door frame protector of claim 1, wherein the tube is a wound paper tube.

11. A method of protecting a door jamb of a door frame, comprising the following steps:
a) providing a tube which is 12-96 inches long and which has a slot extending the entire length of the tube, the tube having a first edge and a second, opposing, edge defined by the slot;
b) increasing a width of the slot and placing the tube around at least a portion of the door jamb and permitting the width of the slot to decrease so that at least a portion of the door jamb is within the tube and the first and second edges of the tube compressively engage a wall adjacent the doorjamb.

12. The method of claim 11, wherein the tube is a paper tube.
